(19) United States
(12) Patent Application Publication
(10) Pub. No.: US 2026/0084354 A1
(43) Pub. Date: Mar. 26, 2026

(54) MOLDING MANAGEMENT SYSTEM

(71) Applicant: SEIKO EPSON CORPORATION, Tokyo (JP)

(72) Inventor: Tomohiro TAKIZAWA, MATSUMOTO-SHI (JP)

(21) Appl. No.: 19/339,586

(22) Filed: Sep. 25, 2025

(30) Foreign Application Priority Data
Sep. 26, 2024 (JP) 2024-167331

(51) Int. Cl. B29C 45/76

(52) U.S. Cl. CPC B29C 45/76; B29C 2045/7606; B29C 2945/76076

(57) ABSTRACT

In a molding management system that manages production of a product in a production process including an injection molding process of the product performed by an injection molding apparatus, an information processing device acquires, for each cycle of executing injection molding, cycle data including one or more pieces of cycle-related information obtained in response to execution of the cycle by the injection molding apparatus and first date-and-time information, acquires injection molding condition data including one or more pieces of injection molding condition information each indicating an injection molding condition set in the injection molding apparatus and second date-and-time information, every time the injection molding condition is set in the injection molding apparatus, and displays, on a display unit, a combination of first cycle data and first association information indicating first injection molding condition data associated with the first cycle data as a first combination.

### CROSS REFERENCE TO RELATED APPLICATIONS

The present application is based on, and claims priority from JP Application Serial Number 2024-167331, filed September 26, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product performed by an injection molding apparatus, has been studied and developed.

Here, a technique is known in which an event that an injection molding condition set in an injection molding apparatus is changed is associated with cycle data in a one-to-many relationship, and one or more pieces of the cycle data with which the event is associated is displayed on a graph whose horizontal axis is a time axis (see JP-A-2020-189459).

JP-A-2020-189459 is an example of the related art.

However, in the technique described in JP-A-2020-189459, since a relation between a cycle of injection molding in the injection molding apparatus and the injection molding condition set in the injection molding apparatus is one-to-many, it may be difficult for a manager of an injection molding process to grasp the situation.

### SUMMARY

An aspect of the disclosure is a molding management system that manages production of a product in a production process including an injection molding process of the product performed by an injection molding apparatus, the molding management system including: an information processing device communicably connected to a terminal device, in which the information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and in response to a received operation, displays, on a display unit, a combination of first cycle data among one or more pieces of the cycle data that are acquired and first association information indicating first injection molding condition data associated with the first cycle data among one or more pieces of the injection molding condition data that are acquired, as a first combination.

### BRIEF DESCRIPTION OF THE DRAWINGS

FIG. 1 is a diagram showing an example of a configuration of a molding management system 1.

FIG. 2 is a diagram showing an example of a search image P1.

FIG. 3 is a diagram illustrating a method of specifying injection molding condition data to be associated with cycle data.

FIG. 4 is a diagram showing an example of a state of the search image P1 in which a search result list is displayed in a search result display region R1.

FIG. 5 is a diagram showing an example of the injection molding condition data output from an information processing device X to a terminal device 40 in response to reception of a selection operation on association information CD1.

FIG. 6 is a diagram showing an example of the search result display region R1 in which injection molding condition change information is displayed.

FIG. 7 is a diagram showing an example of a state where a message is displayed by placing a cursor on injection molding condition change information CG shown in FIG. 6.

FIG. 8 is a diagram showing an example of a state of the search result display region R1 when a selection operation is performed on the injection molding condition change information CG shown in FIG. 6.

FIG. 9 is a diagram showing an example of a state where information indicating the number of times that the injection molding condition set in the injection molding apparatus is changed is displayed in the search result display region R1 shown in FIG. 6.

FIG. 10 is a diagram showing an example of a state where a GUI for receiving filtering conditions is displayed in the search result display region R1 shown in FIG. 6.

FIG. 11 is a diagram showing an example of an image for receiving an operation of selecting one or more pieces of injection molding condition information designated as target injection molding condition information.

FIG. 12 is a diagram showing an example of a plurality of pieces of cycle data downloaded to the terminal device 40.

FIG. 13 is a diagram showing an example of the cycle data and the injection molding condition data downloaded to the terminal device 40.

FIG. 14 is a diagram showing another example of the cycle data and the injection molding condition data downloaded to the terminal device 40.

FIG. 15 is a diagram showing another example of the cycle data and the injection molding condition data downloaded to the terminal device 40.

FIG. 16 is a diagram showing an example of a hardware configuration of the information processing device X.

FIG. 17 is a diagram showing an example of a functional configuration of the information processing device X.

FIG. 18 is a diagram showing an example of a flow of a process performed by the information processing device X in response to an operation received via the search image P1.

FIG. 19 is a diagram showing another example of the state of the search image P1 in which the search result list is displayed in the search result display region R1.

FIG. 20 is a diagram showing still another example of the state of the search image P1 in which the search result list is displayed in the search result display region R1.

FIG. 21 is a diagram showing an example of a plurality of pieces of injection molding condition data downloaded to the terminal device 40.

### DESCRIPTION OF EMBODIMENTS

### Embodiment

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product performed by an injection molding apparatus. The molding management system includes an information processing device. The information processing device is communicably connected to a terminal device. The information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus. The information processing device acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus. Then, in response to a received operation, the information processing device displays, on a display unit, a combination of first cycle data among one or more pieces of the cycle data that are acquired and first association information indicating first injection molding condition data associated with the first cycle data among one or more pieces of the injection molding condition data that are acquired, as a first combination. Accordingly, the molding management system can make it possible to easily grasp a relation between the cycle of the injection molding in the injection molding apparatus and the injection molding condition set in the injection molding apparatus.

The molding management system according to the embodiment manages production of a product in a production process including an injection molding process of the product performed by an injection molding apparatus. The molding management system includes an information processing device. The information processing device is communicably connected to a terminal device. The information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus. The information processing device acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus. Then, in response to a received operation, the information processing device outputs, to another device, a combination of first cycle data among one or more pieces of the cycle data that are acquired and first injection molding condition data associated with the first cycle data among one or more pieces of the injection molding condition data that are acquired. Accordingly, the molding management system can also make it possible to easily grasp the relation between the cycle of the injection molding in the injection molding apparatus and the injection molding condition set in the injection molding apparatus.

In the following description, a configuration of the molding management system according to such an embodiment and processing performed by a server provided in the molding management system will be described in detail.

### Configuration of Molding Management System

Hereinafter, the configuration of the molding management system according to the embodiment will be described by taking a molding management system 1 as an example.

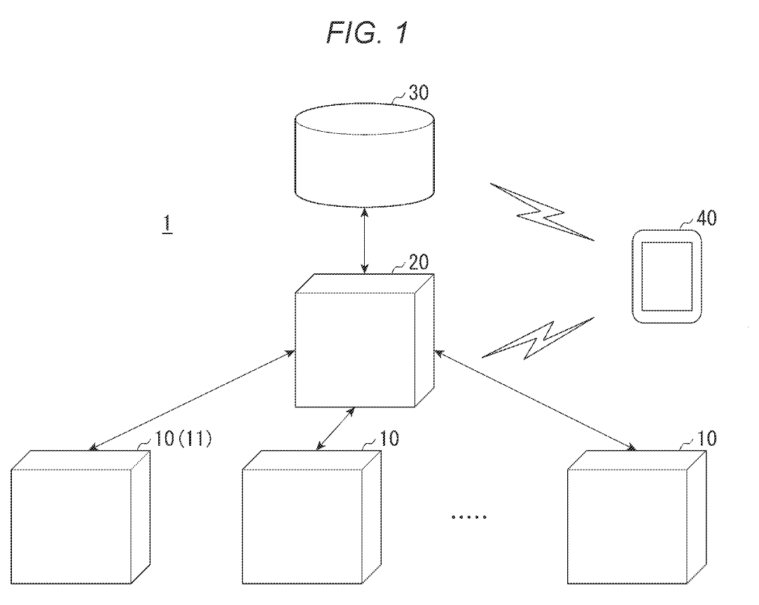

FIG. 1 is a diagram showing an example of a configuration of the molding management system 1.

The molding management system 1 is a type of manufacturing execution system (MES). For example, the molding management system 1 includes one or more managed devices 10, an information processing device 20, and a server 30. The molding management system 1 may not include a part or all of the one or more managed devices 10. The molding management system 1 may include the server 30 without including the information processing device 20. The molding management system 1 may include the information processing device 20 without including the server 30. In the molding management system 1, the information processing device 20 may be configured integrally with the server 30. Hereinafter, as an example, a case in which the molding management system 1 includes a plurality of managed devices 10 as the one or more managed devices 10 will be described. Hereinafter, as an example, a case in which the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same reference numeral. However, a part or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of such an injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Hereinafter, the injection molding apparatus that performs the injection molding of a product using a resin such as plastic is simply referred to as an injection molding apparatus. In addition to the injection molding apparatus, the plurality of managed devices 10 include, for example, peripheral equipment of the injection molding apparatus. Examples of the peripheral equipment of the injection molding apparatus include, but are not limited to, a material supply device that supplies, to the injection molding apparatus, a material used for the injection molding of a product performed by the injection molding apparatus, a conveying device that conveys the product injection-molded by the injection molding apparatus, a cleaning device that cleans the product injection-molded by the injection molding apparatus, and a sintering device that sinters the product cleaned by the cleaning device. At least one injection molding apparatus in the plurality of managed devices 10 may be a device that performs injection molding using a material other than resin and metal.

The molding management system 1 manages production of a product in a production process including an injection molding process of the product performed by the injection molding apparatus included in the plurality of managed devices 10. The injection molding apparatus included in the plurality of managed devices 10 may have any configuration as long as the configuration is capable of producing a product by injection molding. Hereinafter, for convenience of description, a process in which the injection molding apparatus performs injection molding of a product once is referred to as a cycle.

The information processing device 20 acquires cycle data for each cycle from each of the one or more injection molding apparatuses included in the plurality of managed devices 10. More specifically, the information processing device 20 acquires the cycle data from each of the one or more injection molding apparatuses every time each cycle ends. Here, the cycle data acquired from a certain injection molding apparatus in a certain cycle is information including one or more pieces of cycle-related information obtained in response to the execution of the cycle by the injection molding apparatus, apparatus identification information for identifying the injection molding apparatus and first date-and-time information indicating a date and time when the cycle data is acquired by the information processing device 20 from the injection molding apparatus. The cycle data may include other information in addition to the one or more pieces of cycle-related information, the apparatus identification information, and the first date-and-time information. The apparatus identification information is, for example, an identifier (ID) for identifying the injection molding apparatus, but may be other information capable of identifying the injection molding apparatus, such as an Internet Protocol (IP) address assigned to the injection molding apparatus. The apparatus identification information may be contained in the one or more pieces of cycle-related information. Hereinafter, as an example, a case in which the apparatus identification information is contained in the one or more pieces of cycle-related information will be described. In this case, the one or more pieces of cycle-related information include, for example, a part or all of detection information, operation state information, product quantity information, quality information, and the like, in addition to the apparatus identification information. However, the information contained in the one or more pieces of cycle-related information is not limited thereto. The detection information contained in the cycle data as the cycle-related information is information detected by each of one or more various sensors attached to the injection molding apparatus, and is, for example, a part or all of information indicating a temperature, information indicating a pressure, information indicating a current value, information indicating a voltage value, and the like. The operation state information contained in the cycle data as the cycle-related information is information indicating an operation state of the injection molding apparatus. The product quantity information contained in the cycle data as the cycle-related information is information indicating a quantity of products injection-molded in the cycle. The quality information contained in the cycle data as the cycle-related information is information indicating a quality of the product injection-molded in the cycle. The first date-and-time information indicating the date and time when the cycle data is acquired by the information processing device 20 from the injection molding apparatus may be a time stamp or other information indicating the date and time. Each piece of the cycle data including such information can be discriminated by a combination of the apparatus identification information and the first date-and-time information. When there is only one injection molding apparatus connected to the information processing device 20, the cycle data may not include the apparatus identification information. This is because, in this case, the cycle data can be discriminated simply by the first date-and-time information. When a certain piece of cycle data is acquired, the information processing device 20 stores the acquired cycle data and outputs the acquired cycle data to the server 30. Accordingly, the information processing device 20 can also store the acquired cycle data in the server 30.

Further, the information processing device 20 acquires injection molding condition data from each of the one or more injection molding apparatuses included in the plurality of managed devices 10 every time an injection molding condition is set in the injection molding apparatus. Here, the injection molding condition data acquired from a certain injection molding apparatus is information in which one or more pieces of injection molding condition information each indicating the injection molding condition set in the injection molding apparatus, the apparatus identification information for identifying the injection molding apparatus, and second date-and-time information indicating a date and time when the injection molding condition data is acquired by the information processing device 20 from the injection molding apparatus are associated with one another. The injection molding condition data may include other information in addition to the one or more pieces of injection molding condition information, the apparatus identification information, and the second date-and-time information. The apparatus identification information is, for example, an ID for identifying the injection molding apparatus, but may be other information capable of identifying the injection molding apparatus, such as an IP address assigned to the injection molding apparatus. The apparatus identification information may be contained in the one or more pieces of injection molding condition information. Hereinafter, as an example, a case in which the apparatus identification information is contained in the one or more pieces of injection molding condition information will be described. In this case, the one or more pieces of injection molding condition information include, in addition to the apparatus identification information, a part or all of, for example, information indicating an injection speed, information indicating a rotation speed of a screw, information indicating a lower limit value of an injection holding pressure, and information indicating an upper limit value of the injection holding pressure. However, the information contained in the one or more pieces of injection molding condition information is not limited thereto. The second date-and-time information indicating the date and time when the injection molding condition data is acquired by the information processing device 20 from the injection molding apparatus may be a time stamp or other information indicating the date and time. When a certain piece of injection molding condition data is acquired, the information processing device 20 stores the acquired injection molding condition data and outputs the acquired injection molding condition data to the server 30. Accordingly, the information processing device 20 can also store the acquired injection molding condition data in the server 30.

In response to a request from a terminal device communicably connected to the information processing device 20, the information processing device 20 displays, on a display unit of the terminal device, various images based on the data stored in the information processing device 20. Here, the images are a graphical user interface (GUI), an icon, a window on an operating system (OS), and the like. Hereinafter, as an example, a case in which the information processing device 20 is communicably connected to the terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing a certain process in response to a received operation means the information processing device 20 performing the process in response to an operation received from the terminal device 40 via the image displayed on the terminal device 40.

Examples of the information processing device 20 include, but are not limited to, a workstation, a desktop PC (Personal Computer), and a notebook PC. The information processing device 20 is communicably connected to each of the plurality of managed devices 10 by wired or wireless communication. Examples of a communication network that connects the information processing device 20 and each of the plurality of managed devices 10 include, but are not limited to, a Local Area Network (LAN) in a facility in which a plurality of managed devices 10 are installed. The communication network may be another communication network such as the Internet or a mobile communication network.

The server 30 stores the cycle data acquired by the information processing device 20. For example, when a certain piece of cycle data is acquired from the information processing device 20, the server 30 stores the acquired cycle data.

The server 30 stores the injection molding condition data acquired by the information processing device 20. For example, when a certain piece of injection molding condition data is acquired from the information processing device 20, the server 30 stores the acquired injection molding condition data.

In response to a request from a terminal device communicably connected to the server 30, the server 30 displays, on a display unit of the terminal device, various images based on the data stored in the server 30. Here, the images are the GUI, the icon, the window on the OS, and the like. Hereinafter, as an example, a case in which the server 30 is communicably connected to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via an image displayed on the terminal device 40 is simply referred to as the server 30 receiving an operation. That is, hereinafter, the server 30 performing a certain process in response to a received operation means the server 30 performing the process in response to an operation received from the terminal device 40 via the image displayed on the terminal device 40.

As described above, in the molding management system 1, both the information processing device 20 and the server 30 display, in response to the received operation, various images based on the stored data on the display unit of the terminal device 40. Therefore, hereinafter, for convenience of description, the information processing device 20 and the server 30 are collectively referred to as an information processing device X unless it is necessary to distinguish them. Examples of the display unit include, but are not limited to, a display of the terminal device 40 and a display device communicably connected to the terminal device 40. Hereinafter, as an example, a case in which the display unit is the display of the terminal device 40 will be described. Hereinafter, for convenience of description, displaying a certain image on the display unit is referred to as displaying an image.

The information processing device X displays, in response to a received operation, a search image P1 for searching for one or more pieces of cycle data desired by a user among the one or more pieces of cycle data stored in the information processing device X. The search image P1 is an image for receiving various types of information that can be used as a search key for searching for the one or more pieces of cycle data desired by the user. Hereinafter, in order to simplify the description, as an example, a case will be described in which the search image P1 can receive, as the search key, each of the apparatus identification information for identifying the injection molding apparatus that outputs the cycle data and period information indicating a period including the date and time when the cycle data is acquired by the information processing device 20.

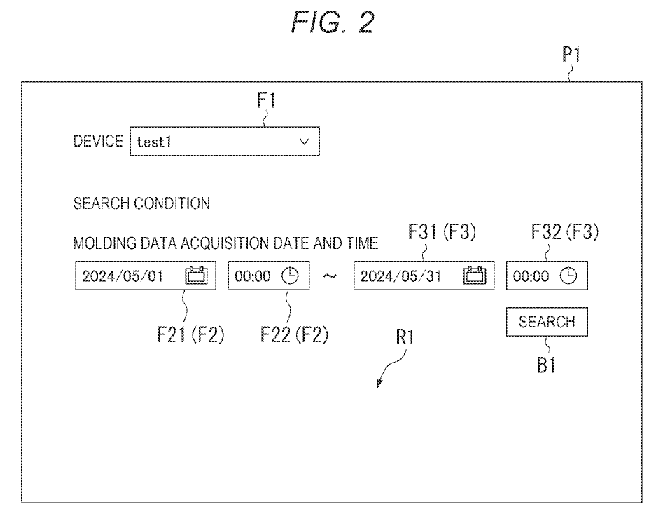

FIG. 2 is a diagram showing an example of the search image P1. In the example shown in FIG. 2, the search image P1 includes an input field F1, an input field F2, an input field F3, a button B1, and a search result display region R1. The search image P1 may include another GUI (graphical user interface) capable of receiving an operation of searching for the cycle data instead of a part or all of these GUIs or in addition to all of these GUIs. Hereinafter, for convenience of description, various operations received by the information processing device X via the search image P1 are collectively referred to as search operations.

The input field F1 is a field for inputting the apparatus identification information for identifying the injection molding apparatus that outputs the cycle data desired by the user. In the example shown in FIG. 2, "test 1" is input to the input field F1 as an example of the apparatus identification information. The apparatus identification information may be input to the input field F1 by selecting the apparatus identification information from a pull-down menu or may be directly input using an input device such as a keyboard.

The input field F2 and the input field F3 are fields for inputting the period information indicating a period including a date and time desired by the user to acquire the cycle data via the information processing device 20. In the example shown in FIG. 2, the input field F2 is a field for inputting start date-and-time information indicating a date and time when the period starts. In this example, the input field F3 is a field for inputting end date-and-time information indicating a date and time when the period ends.

More specifically, the input field F2 includes two input fields, that is, an input field F21 and an input field F22. The input field F21 is a field for inputting start date information indicating a date in the date and time indicated by the start date-and-time information. In the example shown in FIG. 2, in the input field F21, "2024/05/01" indicating May 7, 2024 is input as an example of the start date information. The start date information may be input to the input field F21 by selecting information from a pull-down menu, may be input by selecting a date from an image indicating a calendar, or may be directly input using an input device such as a keyboard. Meanwhile, the input field F22 is a field for inputting start time information indicating a time in the date and time indicated by the start date-and-time information. In the input field F22, "00:00" indicating zero o'clock is input as an example of the start time information. The start time information may be input to the input field F22 by selecting information from a pull-down menu, may be input by designating a time on an image indicating a clock, or may be directly input using an input device such as a keyboard.

The input field F3 includes two input fields, that is, an input field F31 and an input field F32. The input field F31 is a field for inputting end date information indicating a date in the date and time indicated by the end date-and-time information. In the example shown in FIG. 2, in the input field F31, "2024/05/31" indicating May 8, 2024 is input as an example of the end date information. The end date information may be input to the input field F31 by selecting information from a pull-down menu, may be input by selecting a date from an image indicating a calendar, or may be directly input using an input device such as a keyboard. Meanwhile, the input field F32 is a field for inputting end time information indicating a time in the date and time indicated by the end date-and-time information. In the input field F32, "00:00" indicating zero o'clock is input as an example of the end time information. The end time information may be input to the input field F32 by selecting information from a pull-down menu, may be input by designating a time on an image indicating a clock, or may be directly input using an input device such as a keyboard.

The button B1 is a button for receiving an operation of using each piece of information input to a part or all of the input field F1 to the input field F3 as the search key to search for the cycle data based on the search key. That is, when a selection operation on the button B1 is received, the information processing device X extracts, as a search result, one or more pieces of cycle data corresponding to the respective pieces of information input to a part or all of the input field F1 to the input field F3. Then, the information processing device X displays a list of the extracted one or more pieces of cycle data in the search result display region R1. In the present embodiment, the selection operation means a click, a tap, or the like, but is not limited thereto. The search image P1 shown in FIG. 2 is an image before the one or more pieces of cycle data are extracted. Therefore, nothing is displayed in the search result display region R1 shown in FIG. 2. Hereinafter, for convenience of description, the list of one or more pieces of cycle data extracted by the information processing device X is simply referred to as a search result list. A method of extracting one or more pieces of cycle data corresponding to the respective pieces of information input to a part or all of the input field F1 to the input field F3, that is, a method of searching for the one or more pieces of cycle data may be a known method or a method to be developed in the future. Therefore, in the present embodiment, a detailed description of the extraction method will be omitted. When no information is input to all of the input field F1 to the input field F3 and a selection operation is performed on the button B1, the information processing device X may be configured to display a list of all of the one or more pieces of cycle data stored in advance in the search result display region R1 as the search result list, or may be configured to display nothing in the search result display region R1.

When displaying the search result list in the search result display region R1 in this manner, the information processing device X extracts, for each of the one or more pieces of cycle data extracted as the search result, the injection molding condition data corresponding to the cycle data from among the one or more pieces of injection molding condition data stored in advance, and associates the extracted injection molding condition data with the cycle data. At this time, the information processing device X associates one piece of injection molding condition data with one piece of cycle data. That is, the information processing device X associates the cycle data with the injection molding condition data in a one-to-one or many-to-one relationship. Therefore, when the search result list is displayed in the search result display region R1, each piece of cycle data is associated with one piece of injection molding condition data.

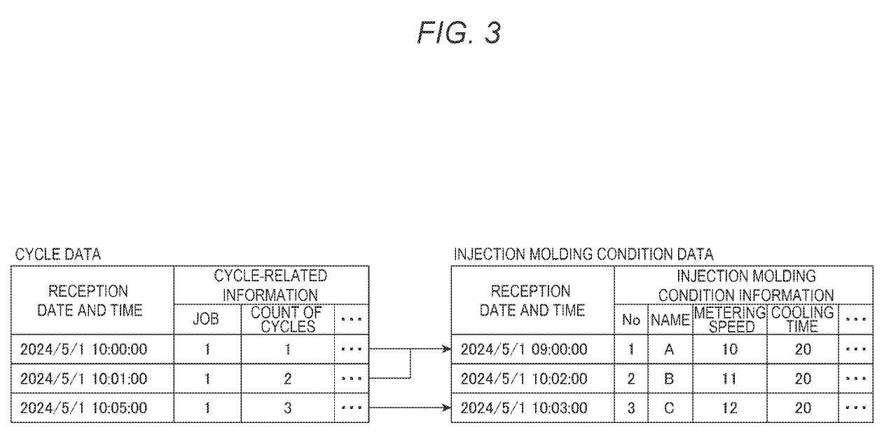

Here, a method of specifying the injection molding condition data associated with each piece of cycle data will be described. When specifying the injection molding condition data to be associated with a certain piece of cycle data, the information processing device X extracts, from among the one or more pieces of injection molding condition data stored in advance, one or more pieces of injection molding condition data including the apparatus identification information contained in the cycle data. Then, the information processing device X specifies, from among the extracted one or more injection molding condition data, the injection molding condition data including the second date-and-time information indicating a past date and time closest to the date and time indicated by the first date-and-time information contained in the cycle data, as the injection molding condition data to be associated with the cycle data. FIG. 3 is a diagram illustrating a method of specifying the injection molding condition data to be associated with the cycle data. FIG. 3 shows three pieces of cycle data output from a certain injection molding apparatus and three pieces of injection molding condition data output from the injection molding apparatus. Specifically, FIG. 3 shows three pieces of cycle data, that is, cycle data containing first date-and-time information indicating 10:00:00 on May 1, 2024, cycle data including first date-and-time information indicating 10:01:00 on May 1, 2024, and cycle data including first date-and-time information indicating 10:05:00 on May 1, 2024. Meanwhile, FIG. 3 shows three pieces of injection molding condition data, that is, injection molding condition data including second date-and-time information indicating 09:00:00 on May 1, 2024, injection molding condition data including second date-and-time information indicating 10:02:00 on May 1, 2024, and injection molding condition data including second date-and-time information indicating 10:03:00 on May 1, 2024. For example, when the three pieces of cycle data shown in FIG. 3 are extracted by the information processing device X in the search image P1 and the three pieces of injection molding condition data shown in FIG. 3 are stored in advance in the information processing device X, the information processing device X specifies the injection molding condition data to be associated with the three pieces of cycle data, from among the three pieces of injection molding condition data. Specifically, the information processing device X specifies, as the injection molding condition data to be associated with the cycle data including the first date-and-time information indicating 10:00:00 on May 1, 2024, the injection molding condition data including the second date-and-time information indicating 09:00:00 on May 1, 2024. This is because, among the three dates and times, that is, 09:00:00 on May 1, 2024, 10:02:00 on May 1, 2024, and 10:03:00 on May 1, 2024, a date and time closest to 10:00:00 on May 1, 2024 is 09:00:00 on May 1, 2024. Similarly, the information processing device X specifies, as the injection molding condition data to be associated with the cycle data including the first date-and-time information indicating 10:01:00 on May 1, 2024, the injection molding condition data including the second date-and-time information indicating 09:00:00 on May 1, 2024. Then, the information processing device X specifies, as the injection molding condition data to be associated with the cycle data including the first date-and-time information indicating 10:05:00 on May 1, 2024, the injection molding condition data including the second date-and-time information indicating 10:03:00 on May 1, 2024. Therefore, in this case, the information processing device X does not specify the injection molding condition data including the second date-and-time information indicating 10:02:00 on May 1, 2024, as the injection molding condition data to be associated with any of the three pieces of cycle data shown in FIG. 3. Accordingly, the information processing device X can omit unnecessary injection molding condition data and associate the injection molding condition data necessary for the user with the cycle data. This is because, for example, when an abnormality occurs in the product injection-molded by the injection molding apparatus, the user can easily grasp the situation, and as a result, a cause of the abnormality occurring in the product can be easily specified. By the specifying method as described above, the information processing device X can associate one piece of injection molding condition data with each of the three pieces of cycle data shown in FIG. 3. As a result, when the information processing device X displays the search result list in the search result display region R1, one piece of injection molding condition data is associated with each piece of cycle data. In FIG. 3, the injection molding condition data is connected, by an arrow, to each piece of cycle data associated therewith. That is, in the example shown in FIG. 3, the information processing device X can associate one piece of injection molding condition data with one piece of cycle data. However, this also means that there may be a plurality of pieces of cycle data associated with a certain piece of injection molding condition data. For example, when an abnormality occurs in the quality of the product molded by injection molding, the user often specifies a cause of the abnormality while viewing the cycle data. Therefore, even if the cycle data and the injection molding condition data are associated with each other in a many-to-one relationship, the information processing device X can prevent work required to specify the cause of the abnormality from being complicated as long as the number of pieces of injection molding condition data associated with each piece of cycle data is one. Therefore, the information processing device X associates one piece of injection molding condition data with one piece of cycle data instead of associating a plurality of pieces of injection molding condition data with one piece of cycle data. Further, for example, usually, the injection molding condition set in the injection molding apparatus is not changed during execution of the cycle. Therefore, even if the injection molding condition is set in the injection molding apparatus a plurality of times before the cycle is executed, the injection molding condition set in the injection molding apparatus during actual execution of the cycle is the injection molding condition set in the injection molding apparatus last before the execution of the cycle is started. Under such circumstances, when the injection molding apparatus outputs a certain piece of cycle data, the injection molding condition set in the injection molding apparatus at the time of outputting the cycle data is the injection molding condition indicated by the injection molding condition data including the second date-and-time information indicating a past date and time closest to the date and time indicated by the first date-and-time information contained in the cycle data. Therefore, the information processing device X associates the cycle data with the injection molding condition data by the method described above. The injection molding condition in the injection molding apparatus is set a plurality of times before the execution of the cycle when an erroneous injection molding condition is set in the injection molding apparatus, when the injection molding condition is changed for some reason, when a trial and error for obtaining a better injection molding condition is executed, or the like. The association between the cycle data and the injection molding condition data may be performed in the information processing device X every time the cycle data is stored in the information processing device X. In this case, when the search result list is displayed in the search result display region R1, one piece of injection molding condition data is already associated with each piece of cycle data extracted as the search result. Therefore, in this case, the information processing device X does not associate the cycle data with the injection molding condition data when displaying the search result list in the search result display region R1.

After each of the extracted one or more pieces of cycle data is associated with one piece of injection molding condition data, the information processing device X displays, in the search result display region R1, association information indicating the injection molding condition data associated with each piece of cycle data, together with the corresponding piece of cycle data contained in the search result list. That is, in the search result display region R1, each piece of cycle data is displayed in the search result display region R1 together with the association information indicating the injection molding condition data associated with the corresponding piece of cycle data. Hereinafter, as an example, a case in which the association information displayed in the search result display region R1 together with a certain piece of cycle data is an image indicating the injection molding condition data associated with the cycle data will be described. The association information may be information other than the image. The association information may be information including at least a part of the injection molding condition data.

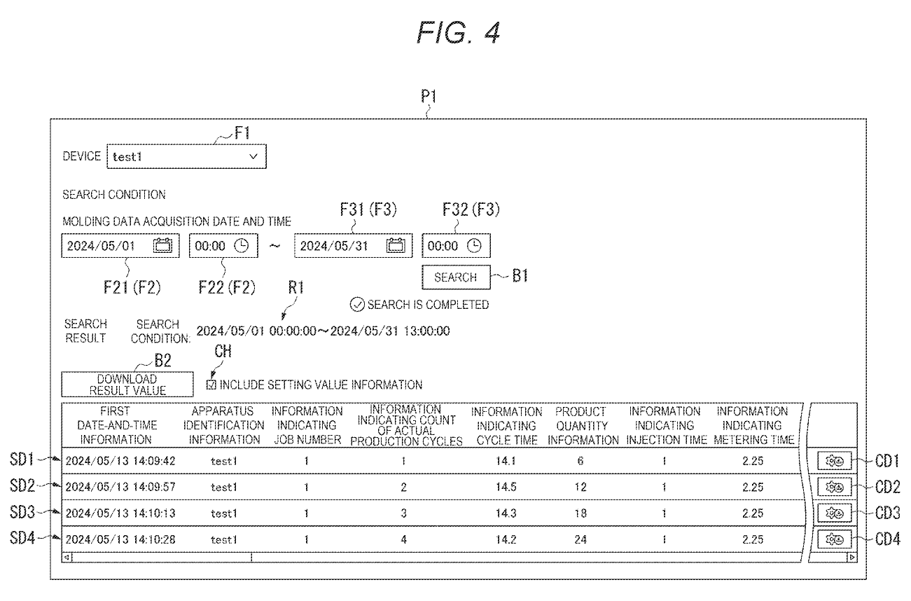

FIG. 4 is a diagram showing an example of the search image P1 in which the search result list is displayed in the search result display region R1. In the example shown in FIG. 4, in the search result display region R1, a search result list including four pieces of cycle data, that is, cycle data SD1 to cycle data SD4 is displayed. In addition to the first date-and-time information and the apparatus identification information, each of the four pieces of cycle data includes, as the cycle-related information, information indicating a job number, information indicating a count of actual production cycles, information indicating a cycle time, the product quantity information, information indicating an injection time, information indicating a metering time, and the like. Further, in the search result display region R1, the association information indicating the injection molding condition associated with each piece of cycle data is displayed in association with a corresponding piece of the four pieces of cycle data. That is, in the search result display region R1, association information CD1 is displayed in association with the cycle data SD1. The association information CD1 is association information indicating the injection molding condition data associated with the cycle data SD1. In the search result display region R1, association information CD2 is displayed in association with the cycle data SD2. The association information CD2 is association information indicating the injection molding condition data associated with the cycle data SD2. In the search result display region R1, association information CD3 is displayed in association with the cycle data SD3. The association information CD3 is association information indicating the injection molding condition data associated with the cycle data SD3. In the search result display region R1, association information CD4 is displayed in association with the cycle data SD4. The association information CD4 is association information indicating the injection molding condition data associated with the cycle data SD4. In this way, when displaying the search result list in the search result display region R1, the information processing device X displays the association information indicating the injection molding condition data associated with respective pieces of cycle data contained in the search result list in the search result display region R1 together with the respective pieces of cycle data. Accordingly, the information processing device X can make it possible to easily grasp the relation between the cycle of injection molding in the injection molding apparatus and the injection molding condition set in the injection molding apparatus. In the example shown in FIG. 4, the association information indicating the injection molding condition data associated with the corresponding piece of cycle data is an image not including the injection molding condition data itself. Therefore, in this example, the user cannot visually grasp the injection molding condition data associated with the corresponding piece of cycle data simply by the information displayed in the search result display region R1 shown in FIG. 4. Therefore, as described above, each piece of association information may include at least a part of the injection molding condition data indicated by the association information. In this case, the user can visually grasp the injection molding condition data associated with the corresponding piece of cycle data simply by the information displayed in the search result display region R1. As a result, the information processing device X can make it possible to more reliably and easily grasp the relation between the cycle of injection molding in the injection molding apparatus and the injection molding condition set in the injection molding apparatus.

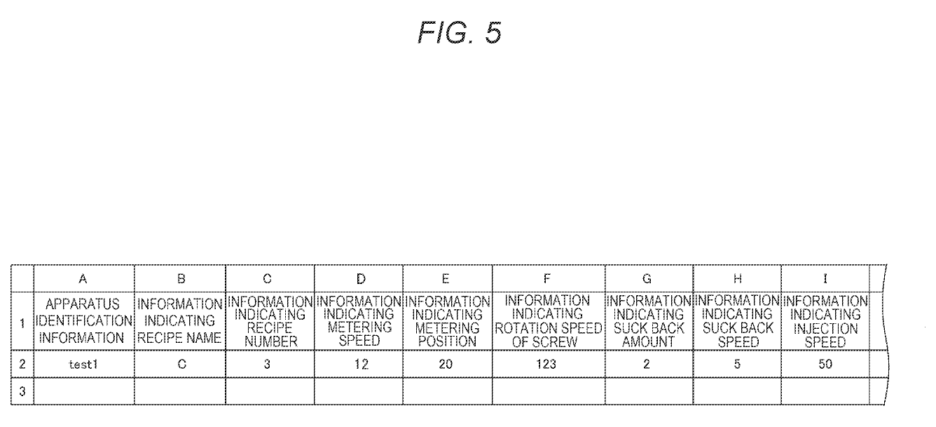

Here, in the example shown in FIG. 4, each of the association information CD1 to the association information CD4 is an image for receiving an operation of outputting the injection molding condition data indicated by a corresponding piece of the association information to another device. The other device may be, for example, the terminal device 40 or another information processing device communicably connected to the information processing device X. Hereinafter, as an example, a case in which the other device is the terminal device 40 will be described. For example, when a selection operation on the association information CD1 is received, the information processing device X outputs the injection molding condition data associated with the cycle data SD1 to the terminal device 40 as the injection molding condition data indicated by the association information CD1. Accordingly, the user can easily download the injection molding condition data to the terminal device 40. The same also applies to each of the association information CD2 to the association information CD4. In this way, by outputting the injection molding condition data to the terminal device 40 by an operation on the association information in this way, when the user wants to acquire desired injection molding condition data, it is not necessary to search for the desired injection molding condition data from among many pieces of injection molding condition data, and the desired injection molding condition data can be easily acquired. This is also useful to prevent the user from acquiring erroneous injection molding condition data. FIG. 5 is a diagram showing an example of the injection molding condition data output from the information processing device X to the terminal device 40 in response to reception of a selection operation on the association information CD1. In the example shown in FIG. 5, the information processing device X outputs the injection molding condition data to the terminal device 40 as a CSV (Comma Separated Values) file. Further, in this example, the injection molding condition data includes, together with the apparatus identification information, information indicating a recipe name, information indicating a recipe number, information indicating a metering speed, information indicating a metering position, information indicating the rotation speed of the screw, information indicating a suck back amount, information indicating a suck back speed, information indicating an injection speed, and the like. In this example, the second date-and-time information is also contained in the injection molding condition data. However, in FIG. 5, the second date-and-time information is located at a position that cannot be seen without scrolling, and is not seen. The information processing device X may be configured to output the injection molding condition data to the terminal device 40 as a file of another format such as a JavaScript Object Notation (JSON) file or an Extensible Markup Language (XML) file instead of the configuration of outputting the injection molding condition data to the terminal device 40 as the CSV file.

As shown in FIG. 4, when displaying the search result list in the search result display region R1, the information processing device X displays the search result list in the search result display region R1 in order of the date and time indicated by the first date-and-time information contained in each piece of cycle data. Specifically, in the search result display region R1 shown in FIG. 4, the four pieces of cycle data are displayed in ascending order of date and time. Accordingly, the information processing device X can confirm the plurality of pieces of cycle data displayed in the search result display region R1 in chronological order. In the search result display region R1, a plurality of pieces of cycle data may be displayed in descending order of date and time.

Further, when the injection molding condition data associated with two pieces of cycle data continuously arranged in time series in the search result display region R1 is different from each other, the information processing device X displays the injection molding condition change information indicating that the injection molding condition is changed in the search result display region R1 in association with the cycle data having a newer one date and time among the date and time indicated by the first date-and-time information contained in the two pieces of cycle data. Here, when there is a difference between one or more pieces of injection molding condition information contained in one of two pieces of injection molding condition data having common apparatus identification information and one or more pieces of injection molding condition information contained in the other of the two pieces of injection molding condition data, the information processing device X specifies that the two pieces of injection molding condition data are different. That is, the information processing device X specifies whether the two pieces of injection molding condition data are different from each other without using information other than the injection molding condition information such as the second date-and-time information. Therefore, even if the injection molding condition data associated with the two pieces of cycle data is data stored in different storage areas of the information processing device X, when there is no difference between the one or more pieces of injection molding condition information contained in each of the two pieces of injection molding condition data, the information processing device X specifies that the two pieces of injection molding condition data are the same.

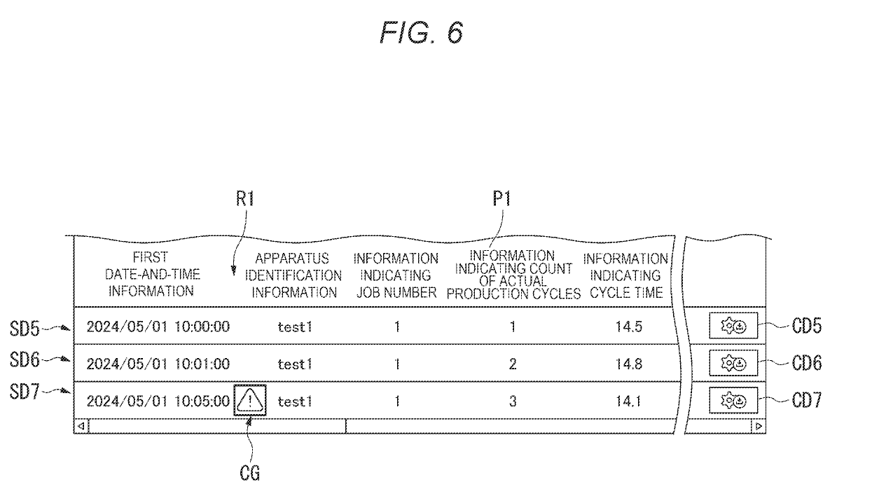

FIG. 6 is a diagram showing an example of the search result display region R1 in which the injection molding condition change information is displayed. In the example shown in FIG. 6, in the search result display region R1, a search result list including three pieces of cycle data, that is, cycle data SD5 to cycle data SD7 is displayed. In this example, association information CD5 associated with the cycle data SD5, association information CD6 associated with the cycle data SD6, and association information CD7 associated with the cycle data SD7 are displayed in the search result display region R1. In this example, the injection molding condition data associated with the cycle data SD6 is different from the injection molding condition data associated with the cycle data SD7. In this case, the injection molding condition data set in the injection molding apparatus identified by "test 1" is changed between execution of a cycle corresponding to the cycle data SD6 and execution of a cycle corresponding to the cycle data SD7. Therefore, in this example, the information processing device X displays injection molding condition change information CG in the search result display region R1 in association with the cycle data SD7. Accordingly, the information processing device X can easily specify that the injection molding condition data set in the injection molding apparatus identified by the "test 1" is changed between the execution of the cycle corresponding to the cycle data SD6 and the execution of the cycle corresponding to the cycle data SD7. As a result, the user can quickly specify, based on, for example, the content of the cycle data and the timing at which the injection molding condition indicated by the injection molding condition information contained in the injection molding condition data is changed, a cause of the abnormality in the quality of the product molded by the injection molding. In FIG. 5, the injection molding condition change information CG is an image indicating that the injection molding condition is changed, but may be other information indicating that the injection molding condition is changed instead.

The information processing device X may be configured to, when displaying the search result list in the search result display region R1, display, for each piece of cycle data, a part of the one or more cycle-related information contained in the corresponding piece of cycle data. In this case, the other part of the one or more cycle-related information contained in each piece of cycle data may be displayed by scrolling, or may be displayed on another image displayed in response to an operation received via a button that is not shown or the like.

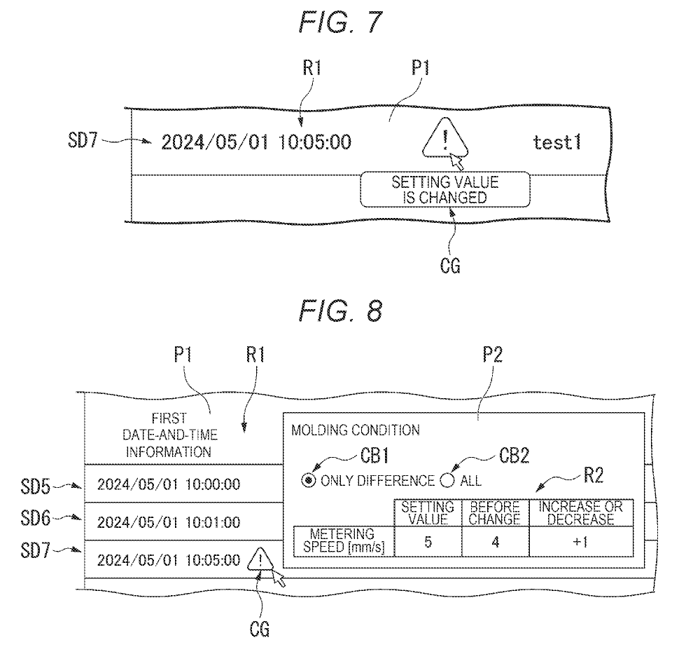

Further, the information processing device X may be configured to display a message indicating that the injection molding condition is changed, as shown in FIG. 7, for example, when a cursor is placed on the injection molding condition change information, such as mouseover. FIG. 7 is a diagram showing an example of a state where the message is displayed by placing the cursor on the injection molding condition change information CG shown in FIG. 6. In the example shown in FIG. 7, the message displayed by placing the cursor on the injection molding condition change information CG is "setting value is changed". Accordingly, even if the user does not understand the meaning represented by the injection molding condition change information CG, the information processing device X can cause the user to easily grasp the meaning. As a result, the information processing device X can more reliably and quickly specify, based on, for example, the content of the cycle data and the timing at which the injection molding condition indicated by the injection molding condition information contained in the injection molding condition data is changed, a cause of the abnormality in the quality of the product molded by the injection molding.

Further, the information processing device X may be configured to, for example, when a cursor is placed on a certain piece of injection molding condition change information such as the mouseover, display information indicating an item of the changed injection molding condition together with at least a part of the injection molding condition data associated with the cycle data displayed in association with the injection molding condition change information. Accordingly, the information processing device X can more easily confirm a content of the injection molding condition data associated with the cycle data.

Further, the information processing device X may be configured to, for example, when a selection operation on the injection molding condition change information is received, display, in the search result display region R1, at least a part of the injection molding condition data associated with the cycle data displayed in association with the injection molding condition change information, as shown in FIG. 8. FIG. 8 is a diagram showing an example of a state of the search result display region R1 when the selection operation is performed on the injection molding condition change information CG shown in FIG. 6. In the example shown in FIG. 8, the information processing device X displays an injection molding condition display image P2 in the search result display region R1 in an overlapping manner, by receiving the selection operation on the injection molding condition change information CG. The injection molding condition display image P2 may have any configuration as long as at least a part of the injection molding condition data associated with the cycle data SD7 displayed in association with the injection molding condition change information CG can be displayed. In this example, the injection molding condition display image P2 includes a check box CB1, a check box CB2, and an injection molding condition display region R2. Instead of a part or all of these GUIs or in addition to all of these GUIs, the injection molding condition display image P2 may include another GUI. Hereinafter, for convenience of description, the injection molding condition data associated with the cycle data SD7 displayed in association with the injection molding condition change information CG is referred to as target injection molding condition data. Hereinafter, for convenience of description, the injection molding condition data associated with the cycle data SD6 is referred to as pre-change injection molding condition data.

The check box CB1 is a check box for receiving an operation of selecting to display a part of the target injection molding condition data in the injection molding condition display region R2. In the example shown in FIG. 8, when the operation is received via the check box CB1, the information processing device X displays, in the injection molding condition display region R2, a difference between the injection molding condition information contained in the pre-change injection molding condition data and the injection molding condition information contained in the target injection molding condition data. That is, in this example, the check box CB1 is a check box for receiving an operation of displaying the difference in the injection molding condition display region R2. In this example, the information processing device X receives the operation via the check box CB1. Therefore, a check mark indicating that the operation is received is displayed in the check box CB1. Therefore, in this example, information indicating the metering speed that is the difference is displayed in the injection molding condition display region R2. Specifically, in this example, in the injection molding condition display region R2, information indicating a metering speed, which is one piece of injection molding condition information contained in the target injection molding condition data, information indicating a metering speed, which is one piece of injection molding condition information contained in the pre-change injection molding condition data, and information indicating a difference between these metering speeds are displayed. Thus, the information processing device X makes it possible for the user to quickly specify the difference. In FIG. 8, the information indicating the metering speed, which is one piece of injection molding condition information contained in the target injection molding condition data, is labeled with "setting value". In FIG. 8, the information indicating the metering speed, which is one piece of injection molding condition information contained in the pre-change injection molding condition data, is labeled with "pre-change". In FIG. 8, the information indicating the difference between the metering speeds is labeled with "increase or decrease".

The check box CB2 is a check box for receiving an operation of selecting to display all pieces of the target injection molding condition data in the injection molding condition display region R2. When the operation is received via the check box CB2, the information processing device X displays, in the injection molding condition display region R2, all pieces of the injection molding condition information contained in the target injection molding condition data.

As described above, the injection molding condition display region R2 is a region in which the injection molding condition corresponding to the selection operation on the check box CB1 or the check box CB2 is displayed.

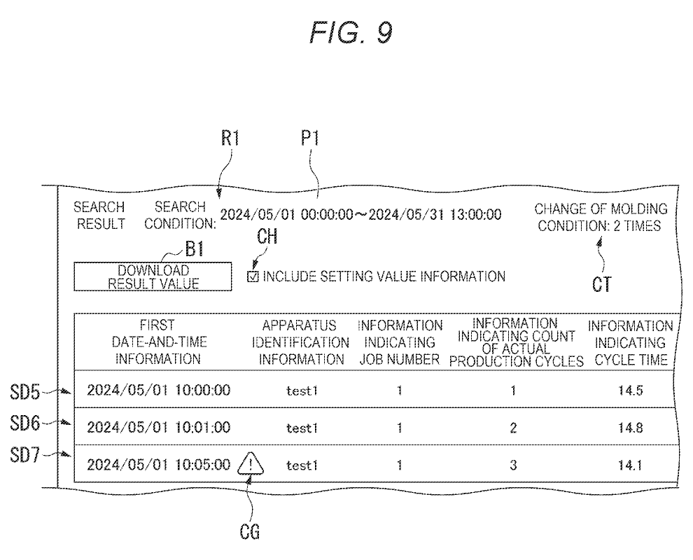

Further, in the injection molding condition data associated with each of the plurality of pieces of cycle data continuously arranged in time series in the search result display region R1, information indicating the number of pieces of non-duplicated injection molding condition data may be displayed in the search result display region R1 as information indicating the number of times that the injection molding condition set in the injection molding apparatus is changed. Here, the non-duplicated injection molding condition data is, in other words, the injection molding condition data determined by the information processing device X to be different from each other. In the example shown in FIG. 6, in the injection molding condition data associated with each of the cycle data SD5 to the cycle data SD7, the number of pieces of non-duplicated injection molding condition data is 2. This is because, in a cycle corresponding to the cycle data SD5 and a cycle corresponding to the cycle data SD6, the injection molding condition set in the injection molding apparatus identified by the apparatus identification information contained in these two pieces of cycle data is not changed. In this case, as shown in FIG. 9, the information processing device X displays, in the search result display region R1, information indicating the number of times that the injection molding condition set in the injection molding apparatus is changed. FIG. 9 is a diagram showing an example of a state where the information indicating the number of times that the injection molding condition set in the injection molding apparatus is changed is displayed in the search result display region R1 shown in FIG. 6. In the example shown in FIG. 9, the information processing device X displays information CT as the information indicating the number of times. In this example, the information CT is "change of molding condition: 2 times" indicating 2 as the number of times. Accordingly, the information processing device X can easily specify a frequency of changing the injection molding condition set in the injection molding apparatus. This leads to an increase in an amount of information to be given to the user to specify the cause of the abnormality in the quality of the product molded by injection molding, which is useful.

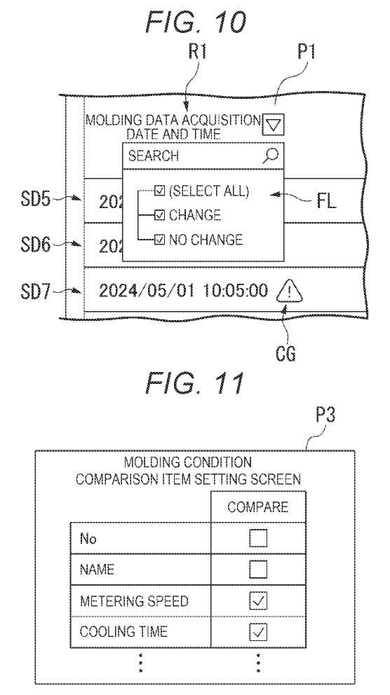

The information processing device X may be configured to filter one or more pieces of cycle data contained in the search result list displayed in the search result display region R1. In other words, the information processing device X may be configured not to display, in the search result display region R1, a combination corresponding to the received operation in a displayed list of combinations each including the cycle data and the association information. For example, the information processing device X displays, in the search result display region R1, a GUI for receiving filtering conditions as shown in FIG. 10. FIG. 10 is a diagram showing an example of a state where the GUI for receiving filtering conditions is displayed in the search result display region R1 shown in FIG. 6. In the example shown in FIG. 10, the information processing device X displays a filtering condition reception image FL in the search result display region R1 as such a GUI. For example, the information processing device X displays the filtering condition reception image FL in the search result display region R1 in response to the received operation. In this example, the filtering condition reception image FL is an image for receiving at least one filtering condition of a first filtering condition and a second filtering condition. The first filtering condition is a filtering condition for displaying only one or more pieces of cycle data, to each of which the injection molding condition change information is displayed in association, among the one or more pieces of cycle data displayed in the search result display region R1. In the filtering condition reception image FL, the user can select the first filtering condition by performing a selection operation on a check box of "change". Meanwhile, the second filtering condition is a filtering condition for displaying only one or more pieces of cycle data that are not displayed in association with the injection molding condition change information among the one or more pieces of cycle data displayed in the search result display region R1. In the filtering condition reception image FL, the user can select the second filtering condition by performing a selection operation on a check box of "no change". The user can select both the first filtering condition and the second filtering condition by performing a selection operation on a check box of "(select all)". The information processing device X displays, in the search result display region R1, one or more pieces of cycle data satisfying the filtering condition selected via the filtering condition reception image FL among the cycle data displayed in the search result display region R1. That is, the information processing device X does not display one or more pieces of cycle data that do not satisfy the filtering condition in the search result display region R1. Accordingly, the information processing device X can display only the cycle data desired by the user in the search result display region R1. As a result, the information processing device X can prevent the information provided to the user from becoming excessive.

Further, the information processing device X may be configured to specify whether the injection molding condition data associated respectively with two pieces of cycle data are different from each other, by comparing the injection molding condition information of a type designated by a received operation among all types of injection molding condition information contained in each of the two pieces of injection molding condition data. For example, the information processing device X specifies whether the injection molding condition data associated with the two pieces of cycle data is different, based on whether the information indicating the metering speed designated by the operation is different. Further, for example, the information processing device X specifies whether the injection molding condition data associated with the two pieces of cycle data is different, based on whether information indicating a cooling time designated by the operation is different. Hereinafter, for convenience of description, the injection molding condition information thus designated by the operation is referred to as target injection molding condition information. Here, FIG. 11 is a diagram showing an example of an image for receiving the operation of selecting one or more pieces of injection molding condition information designated as the target injection molding condition information. An image P3 shown in FIG. 11 is an example of an image for receiving the operation of selecting one or more pieces of injection molding condition information designated as target injection molding condition information. In the example shown in FIG. 11, a list of the injection molding condition information is displayed in the image P3. Each piece of injection molding condition information contained in the list is associated with a check box. When a selection operation on a certain check box is received, the information processing device X specifies the injection molding condition information associated with the check box as the target injection molding condition information. In this way, the information processing device X can specify the target injection molding condition information according to the received operation. After specifying one or more pieces of target injection molding condition information, the information processing device X specifies whether the injection molding condition data associated with the two pieces of cycle data are different from each other by the specified one or more pieces of target injection molding condition information. For example, when a certain piece of injection molding condition information is specified as the target injection molding condition information, the information processing device X specifies whether the injection molding condition data associated with the two pieces of cycle data is different, based on whether the specified target injection molding condition information is different. Accordingly, the information processing device X can display the injection molding condition change information in the search result display region R1 in response to whether the injection molding condition desired by the user is changed. As a result, the information processing device X makes it possible for the user to easily select necessary information.

Return to FIG. 4. The search result display region R1 further includes a button B2 and a check box CH associated with the button B2. Here, in the check box CH, a check mark is displayed when a selection operation is received in a state where no check mark is displayed. On the other hand, in the check box CH, when the selection operation is received in a state where the check mark is displayed, the displayed check mark is deleted.

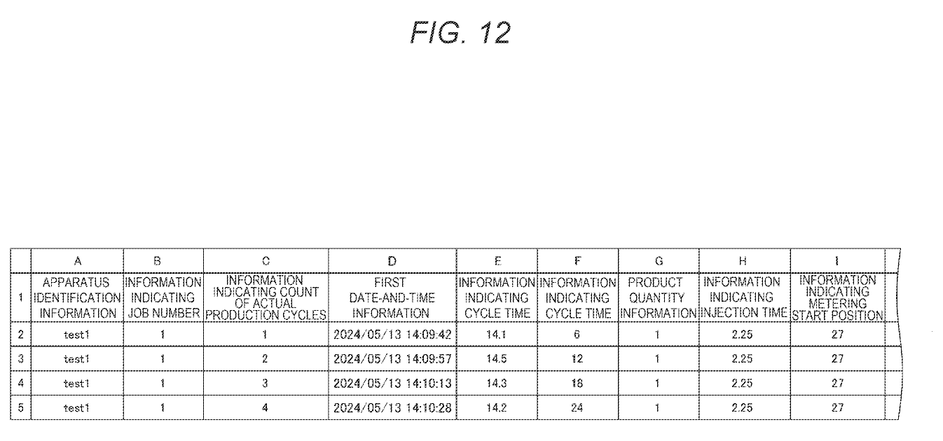

The button B2 is a button for receiving an operation of outputting one or more pieces of cycle data displayed in the search result display region R1 to another device. However, when a selection operation on the button B2 is received in a state where no check mark is displayed in the check box CH, the information processing device X outputs the one or more pieces of cycle data displayed in the search result display region R1 to the other device. The other device may be, for example, the terminal device 40 or another information processing device communicably connected to the information processing device X. Hereinafter, as an example, a case in which the other device is the terminal device 40 will be described. In the example shown in FIG. 4, the information processing device X outputs the cycle data SD1 to the cycle data SD4 to the terminal device 40 when a selection operation on the button B2 is received in a state where no check mark is displayed in the check box CH. Accordingly, for example, the user can easily acquire the cycle data displayed in the search result display region R1. In other words, for example, the user can easily download the cycle data displayed in the search result display region R1 to the terminal device 40. FIG. 12 is a diagram showing an example of a plurality of pieces of cycle data downloaded to the terminal device 40. In the example shown in FIG. 12, the cycle data downloaded to the terminal device 40 is four pieces of cycle data, that is, the cycle data SD1 to the cycle data SD4. That is, when receiving a selection operation on the button B2 shown in FIG. 4 in a state where no check mark is displayed in the check box CH, the information processing device X outputs the four pieces of cycle data to the terminal device 40. In the example shown in FIG. 12, the information processing device X outputs the cycle data to the terminal device 40 as a CSV file. The information processing device X may be configured to output the cycle data to the terminal device 40 in another format, instead of the CSV file.

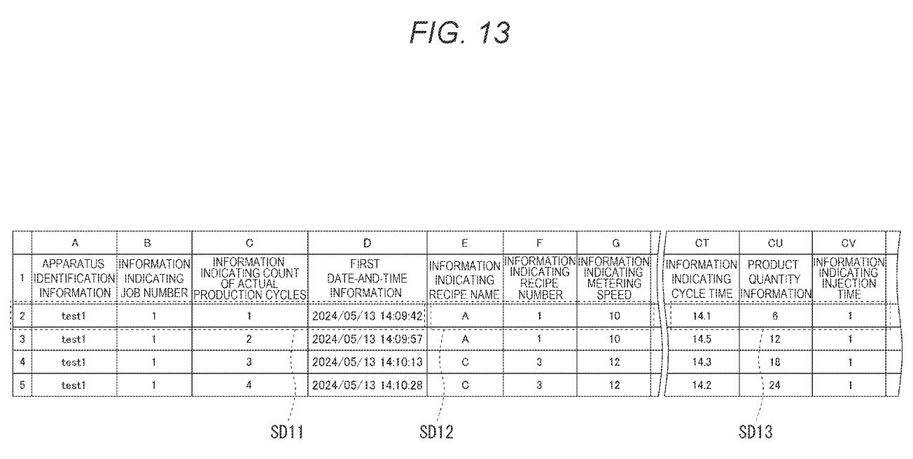

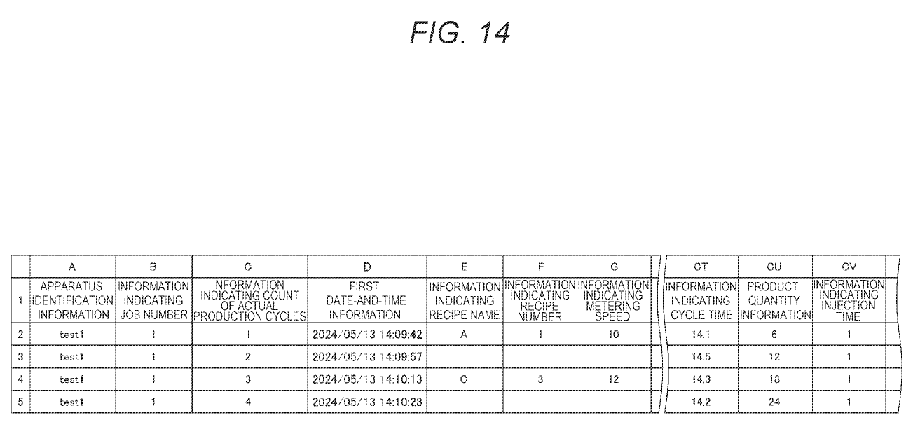

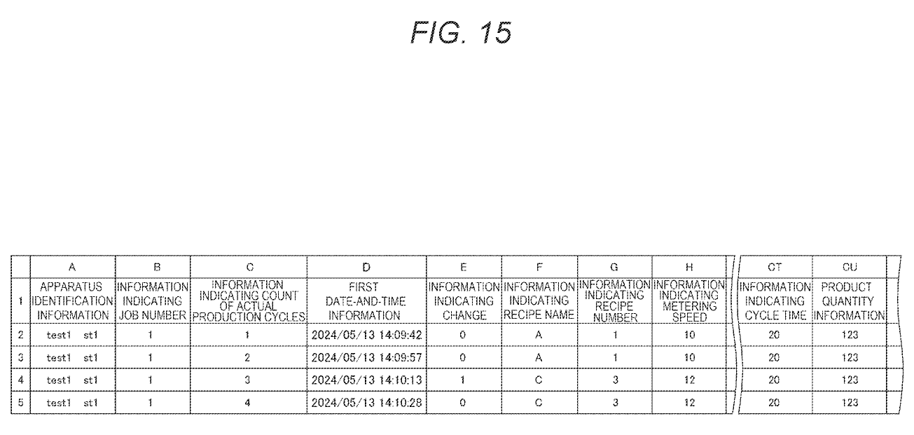

On the other hand, when receiving the selection operation on the button B2 in a state where the check mark is displayed in the check box CH, the information processing device X outputs, to the terminal device 40, the one or more pieces of cycle data displayed in the search result display region R1 and the injection molding condition data associated with each of the one or more pieces of cycle data. In the example shown in FIG. 4, in this case, the information processing device X outputs, to the terminal device 40, a combination of the cycle data SD1 and the injection molding condition data associated with the cycle data SD1, a combination of the cycle data SD2 and the injection molding condition data associated with the cycle data SD2, a combination of the cycle data SD3 and the injection molding condition data associated with the cycle data SD3, and a combination of the cycle data SD4 and the injection molding condition data associated with the cycle data SD4. Accordingly, for example, the user can easily acquire the cycle data displayed in the search result display region R1 and the injection molding condition data associated with the cycle data. In other words, for example, the user can easily download the cycle data displayed in the search result display region R1 and the injection molding condition data associated with the cycle data to the terminal device 40. As a result, the information processing device X can make it possible to easily grasp the relation between the cycle of injection molding in the injection molding apparatus and the injection molding condition set in the injection molding apparatus. FIG. 13 is a diagram showing an example of the cycle data and the injection molding condition data downloaded to the terminal device 40. In the example shown in FIG. 13, the data downloaded to the terminal device 40 is four combinations including the combination of the cycle data SD1 and the injection molding condition data associated with the cycle data SD1, the combination of the cycle data SD2 and the injection molding condition data associated with the cycle data SD2, the combination of the cycle data SD3 and the injection molding condition data associated with the cycle data SD3, and the combination of the cycle data SD4 and the injection molding condition data associated with the cycle data SD4. That is, when a selection operation on the button B2 shown in FIG. 4 is received in a state where the check mark is displayed in the check box CH, the information processing device X outputs the four combinations to the terminal device 40. In the example shown in FIG. 13, the information processing device X outputs the four combinations to the terminal device 40 as a CSV file. The information processing device X may be configured to output these four combinations to the terminal device 40 in another format, instead of the CSV file. Hereinafter, for convenience of description, the four combinations will be referred to as download data. The information processing device X may be configured to, when the selection operation on the button B2 is received in a state where the check mark is displayed in the check box CH, generate the download data by deleting rows other than rows including the one or more pieces of cycle data to which injection molding condition change information is displayed in association, and output the generated download data to the terminal device 40. Further, the information processing device X may be configured to, when the selection operation on the button B2 is received in a state where the check mark is displayed in the check box CH, generate the download data by changing, to null information, all of fields of the injection molding condition information in rows other than rows including the cycle data to which the injection molding condition change information is displayed in association, and output the generated download data to the terminal device 40, as shown in FIG. 14. In other words, in this case, the information processing device X may be configured to generate the download data by changing, to null information, all the fields of the injection molding condition information in rows in each of which the injection molding condition is changed, and output the generated download data to the terminal device 40. FIG. 14 is a diagram showing another example of the cycle data and the injection molding condition data downloaded to the terminal device 40. Further, the information processing device X may be configured to, when the selection operation on the button B2 is received in a state where the check mark is displayed in the check box CH, generate the download data by adding, to each row of the data to be output to the terminal device 40, a field displaying information indicating whether the row is one including the cycle data to which the injection molding condition change information is displayed in association, and output the generated download data to the terminal device 40, as shown in FIG. 15. FIG. 15 is a diagram showing another example of the cycle data and the injection molding condition data downloaded to the terminal device 40. In FIG. 15, the field is labeled with "information indicating change". In the field, "0" indicates a row showing the cycle data in which the injection molding condition change information is not displayed. Meanwhile, in the field, "1" indicates a row showing the cycle data in which the injection molding condition change information is displayed. In the download data shown in FIG. 14 and the download data shown in FIG. 15, the user can visually recognize the timing at which the injection molding condition is changed. This is useful because work using the download data for specifying the cause of the abnormality in the product can be facilitated.

In the example shown in FIG. 13, in each of the four combinations output to the terminal device 40 as the CSV file, the cycle data and the injection molding condition data are arranged in order of a part of the cycle data, the injection molding condition data, and the other part of the cycle data. For example, in this example, in an uppermost row, the cycle data SD1 and the injection molding condition data associated with the cycle data SD1 are arranged in order of data SD11 which is a part of the cycle data SD1, data SD12 which is injection molding condition data associated with the cycle data SD1, and data SD13 which is the other part of the cycle data SD1. The same applies to the download data shown in FIGS. 14 and 15. Accordingly, the information processing device X can improve visibility of the relation between the cycle data and the injection molding condition data, and make it possible to more reliably and easily grasp the relation between the cycle of injection molding in the injection molding apparatus and the injection molding condition set in the injection molding apparatus. In each of the four combinations output to the terminal device 40 as the CSV file, a part of the cycle data, the other part of the cycle data, a part of the injection molding condition data, and the other part of the injection molding condition data may be arranged in any order. For example, a part of the cycle data, the other part of the cycle data, a part of the injection molding condition data, and the other part of the injection molding condition data may be arranged in order of a part of the cycle data, the other part of the cycle data, a part of the injection molding condition data, and the other part of the injection molding condition data in each of the four combinations. This is equivalent to the cycle data and the injection molding condition data being arranged in order of the cycle data and the injection molding condition data in each of the four combinations. For example, a part of the cycle data, the other part of the cycle data, a part of the injection molding condition data, and the other part of the injection molding condition data may be arranged in order of a part of the injection molding condition data, a part of the cycle data, the other part of the cycle data, and the other part of the injection molding condition data in each of the four combinations.

### HARDWARE CONFIGURATION OF INFORMATION PROCESSING DEVICE X

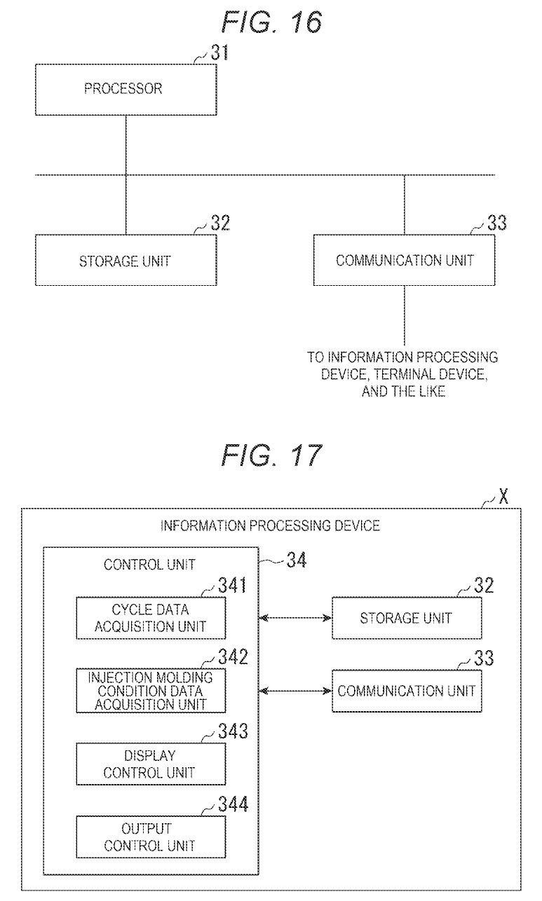

Here, the information processing device 20 and the server 30 may have the same hardware configuration or may have different hardware configurations. Hereinafter, as an example, a case in which the information processing device 20 and the server 30 have the same hardware configuration will be described. In other words, in this example, the information processing device X has a hardware configuration as shown in FIG. 16. FIG. 16 is a diagram showing an example of a hardware configuration of the information processing device X.

The information processing device X includes, for example, a processor 31, a storage unit 32, and a communication unit 33. These component elements are communicably connected to one another via a bus. The information processing device X communicates with other devices via the communication unit 33. For example, when the information processing device X is the information processing device 20, the other devices are the injection molding apparatus, the server 30, the terminal device 40, and the like. For example, when the information processing device X is the server 30, the other devices are the information processing device 20, the terminal device 40, and the like.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device X, the storage unit 32 may be an external storage device connected to a digital input and output port such as a USB (Universal Serial Bus). The storage unit 32 stores various types of information, various images, and various programs to be processed by the information processing device X. That is, the various types of information stored in the information processing device X are stored in the storage unit 32.

The communication unit 33 is a communication device including, for example, a digital input and output port such as a USB, an Ethernet (registered trademark) port, and an antenna for wireless communication.

### FUNCTIONAL CONFIGURATION OF INFORMATION PROCESSING DEVICE X

Here, the information processing device 20 and the server 30 may have the same functional configuration or may have different functional configurations. Hereinafter, as an example, a case in which the information processing device 20 and the server 30 have the same functional configuration will be described. In other words, in this example, the information processing device X has a functional configuration as shown in FIG. 17. FIG. 17 is a diagram showing an example of a functional configuration of the information processing device X.

### THE INFORMATION PROCESSING DEVICE X INCLUDES THE STORAGE UNIT 32, THE COMMUNICATION UNIT 33, AND A CONTROL UNIT 34.

The control unit 34 controls the entire information processing device X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large scale integration (LSI) or an application specific integrated circuit (ASIC).

The cycle data acquisition unit 341 acquires the cycle data for each cycle of each injection molding apparatus from a device communicably connected to the information processing device X. Examples of the device include the injection molding apparatus and the information processing device 20.

The injection molding condition data acquisition unit 342 acquires injection molding condition data from a device communicably connected to the information processing device X every time the injection molding condition is set in each injection molding apparatus. Examples of the device include the injection molding apparatus and the information processing device 20.

The display control unit 343 generates various images in response to the received operation. For example, the display control unit 343 generates the search image P1. The display control unit 343 transmits the generated images to the terminal device 40 and displays the images on the terminal device 40.

The output control unit 344 outputs various types of data to another device in response to the received operation. For example, the output control unit 344 outputs the download data to another device in response to the operation received via the search image P1.

### PROCESS PERFORMED BY INFORMATION PROCESSING DEVICE X IN RESPONSE TO OPERATION RECEIVED VIA SEARCH IMAGE P1

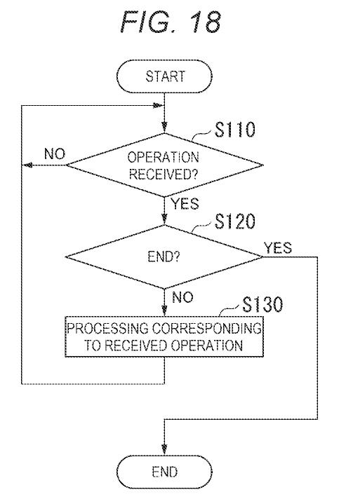

Process performed by the information processing device X in response to the operation received via the search image P1 will be described with reference to FIG. 18. FIG. 18 is a diagram showing an example of a flow of the process performed by the information processing device X in response to the operation received via the search image P1. Hereinafter, as an example, a case in which the search image P1 is displayed on the terminal device 40 at a timing before processing in step S110 shown in FIG. 18 is performed will be described. Hereinafter, as an example, a case in which a plurality of pieces of cycle data and a plurality of pieces of injection molding condition data are already stored in the information processing device X at the timing will be described.

After the search image P1 is displayed, the control unit 34 waits until an operation is received via the search image P1 displayed on the terminal device 40 (step S110). In FIG. 18, the processing in step S110 is indicated by "operation received?".

When it is determined that the operation is received via the search image P1 displayed on the terminal device 40 (step S110-YES), the control unit 34 determines whether the received operation is an operation of ending the processing in the flowchart shown in FIG. 18 (step S120). The control unit 34 may perform the determination processing in step S120 by a known method or by a method to be developed in the future. In FIG. 18, the processing in step S120 is indicated by "end?".

When it is determined that the operation received in step S110 is an operation of ending the processing in the flowchart shown in FIG. 18 (step S120-YES), for example, the control unit 34 deletes the display of the search image P1 from the terminal device 40 and ends the processing in the flowchart shown in FIG. 18.

On the other hand, when it is determined that the operation received in step S110 is not an operation of ending the processing in the flowchart shown in FIG. 18 (step S120-NO), the control unit 34 performs processing corresponding to the received operation (step S130). The processing includes various types of processing described as the processing performed by the information processing device X in the present embodiment. Here, since the processing performed by the control unit 34 in step S130 is already described with reference to FIG. 2 to FIG. 15, a detailed description of the processing will be omitted.

After the processing in step S130 is performed, the control unit 34 transitions to step S110 and waits again until an operation is received via the search image P1 displayed on the terminal device 40.

By the processing as described above, the information processing device X acquires, for each cycle, the cycle data including the one or more pieces of cycle-related information and the first date-and-time information. The information processing device X acquires the injection molding condition data including the one or more pieces of injection molding condition information and the second date-and-time information, every time the injection molding condition is set in the injection molding apparatus. Then, in response to a received operation, the information processing device X displays a combination of a certain piece of cycle data among one or more pieces of the cycle data that are acquired and the association information indicating the injection molding condition data associated with the cycle data among one or more pieces of the injection molding condition data that are acquired. Accordingly, the information processing device X can make it possible to easily grasp the relation between the cycle of injection molding in the injection molding apparatus and the injection molding condition set in the injection molding apparatus.

Further, the information processing device X acquires, for each cycle, the cycle data including the one or more pieces of cycle-related information and the first date-and-time information. The information processing device X acquires the injection molding condition data including the one or more pieces of injection molding condition information and the second date-and-time information, every time the injection molding condition is set in the injection molding apparatus. Then, in response to a received operation, the information processing device X outputs, to another device, a combination of a certain piece of cycle data among one or more pieces of the cycle data that are acquired and the injection molding condition data associated with the cycle data among one or more pieces of the injection molding condition data that are acquired. Accordingly, the information processing device X can also make it possible to easily grasp the relation between the cycle of injection molding in the injection molding apparatus and the injection molding condition set in the injection molding apparatus.

The molding management system 1 described above may include the terminal device 40. The molding management system 1 described above may include an injection molding apparatus such as the injection molding apparatus 11.

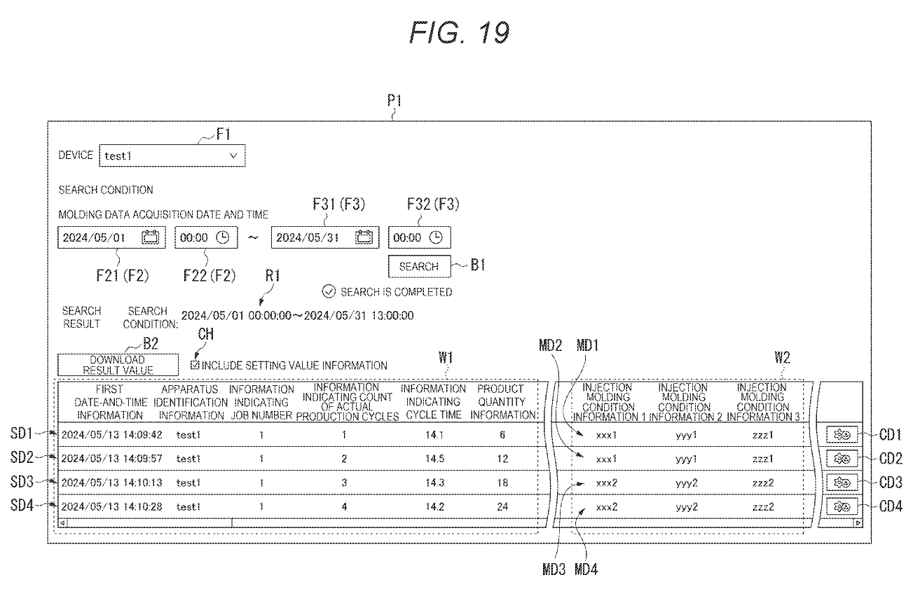

The information processing device X described above may be configured to, when displaying the search result list in the search result display region R1, display the cycle data and the injection molding condition data associated with the cycle data in the search result display region R1, for each piece of cycle data contained in the search result list. For example, as shown in FIG. 19, the information processing device X may be configured to display, for each piece of cycle data, the cycle data, the injection molding condition data associated with the cycle data, and the association information indicating the injection molding condition data, in the search result display region R1. FIG. 19 is a diagram showing another example of the state of the search image P1 in which the search result list is displayed in the search result display region R1. In the example shown in FIG. 19, in each piece of cycle data displayed in the search result display region R1, the injection molding condition data associated with the cycle data and the association information indicating the injection molding condition data are displayed. Specifically, in this example, injection molding condition data MD1 associated with the cycle data SD1 and the association information CD1 indicating the injection molding condition data MD1 are displayed in association with the cycle data SD1. Further, in this example, injection molding condition data MD2 associated with the cycle data SD2 and the association information CD2 indicating the injection molding condition data MD2 are displayed in association with the cycle data SD2. In this example, injection molding condition data MD3 associated with the cycle data SD3 and the association information CD3 indicating the injection molding condition data MD3 are displayed in association with the cycle data SD3. In this example, injection molding condition data MD4 associated with the cycle data SD4 and the association information CD4 indicating the injection molding condition data MD4 are displayed in association with the cycle data SD4. That is, data surrounded by a frame W1 shown in FIG. 19 is the cycle data. Data surrounded by a frame W2 shown in FIG. 19 is the injection molding condition data. In this way, the information processing device X can display, for each piece of cycle data contained in the search result list, the cycle data and the injection molding condition data associated with the cycle data in the search result display region R1. As a result, the information processing device X can make it possible to more reliably and easily grasp the relation between the cycle of injection molding in the injection molding apparatus and the injection molding condition set in the injection molding apparatus. In the example shown in FIG. 19, the information processing device X may be configured not to display the association information in the search result display region R1.

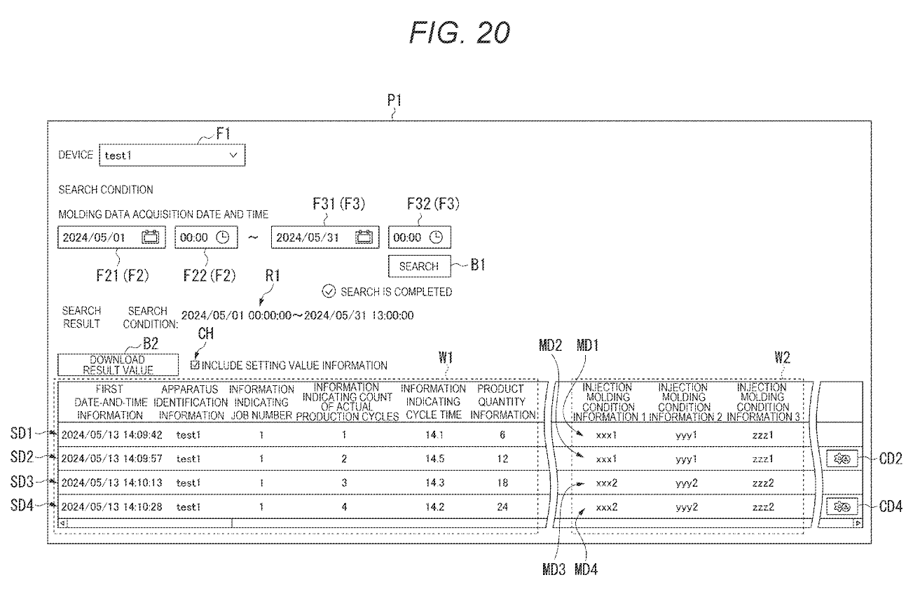

The information processing device X described above may be configured to display the association information as the injection molding condition change information in the example shown in FIG. 19. In this case, as shown in FIG. 20, the information processing device X displays, for only the cycle data in which the injection molding condition change information is displayed, the association information in association with the cycle data. FIG. 20 is a diagram showing still another example of the state of the search image P1 in which the search result list is displayed in the search result display region R1. In the example shown in FIG. 20, the association information CD1 is displayed in association with the cycle data SD1. In this example, the association information CD2 is displayed in association with the cycle data SD2. This is because the injection molding condition data MD1 associated with the cycle data SD1 and the injection molding condition data MD2 associated with the cycle data SD2 are the same injection molding condition data. Similarly, in this example, the association information CD3 is displayed in association with the cycle data SD3. In this example, the association information CD4 is displayed in association with the cycle data SD4. This is because the injection molding condition data MD3 associated with the cycle data SD3 and the injection molding condition data MD4 associated with the cycle data SD4 are the same injection molding condition data. In this way, the information processing device X can display, in the search result display region R1, the association information displayed in association with the cycle data as the injection molding condition change information. As a result, the user can quickly specify, based on, for example, the content of the cycle data and the timing at which the injection molding condition indicated by the injection molding condition information contained in the injection molding condition data is changed, a cause of the abnormality in the quality of the product molded by the injection molding.

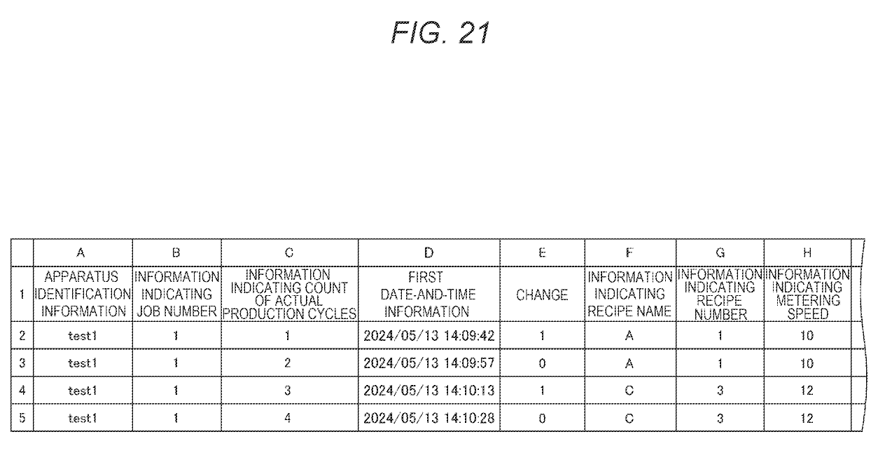

The information processing device X may be configured to output all the injection molding condition data desired by the user to another device in response to the received operation. In this case, for example, the search result display region R1 of the search image P1 includes, for example, a GUI for receiving an operation of selecting the injection molding condition data desired by the user and a GUI for receiving an operation of outputting all the injection molding condition data selected by the GUI to the other device. Here, the other device is, for example, the terminal device 40 or the like, but is not limited thereto. FIG. 21 is a diagram showing an example of a plurality of pieces of injection molding condition data downloaded to the terminal device 40. In the example shown in FIG. 21, a field including change presence-absence information indicating presence or absence of a change in the injection molding condition is labeled with "change". Hereinafter, for convenience of description, when two pieces of injection molding condition data continuously arranged in time series are different from each other, the injection molding condition data having a newer date and time among the date and time indicated by the second date-and-time information contained in the two pieces of injection molding condition data is referred to as changed injection molding condition data, and the injection molding condition data other than the changed injection molding condition data is referred to as unchanged injection molding condition data. In this example, the change presence-absence information of the changed injection molding condition data is indicated by "1", and the change presence-absence information of the unchanged injection molding condition data is indicated by "0". Accordingly, the user can easily specify the timing at which the injection molding condition is changed, by viewing a list of the injection molding condition data downloaded to the terminal device 40. The information processing device X may be configured to receive an operation of selecting whether to include the change presence-absence information in each of the plurality of injection molding condition data downloaded to the terminal device 40. In this case, for example, the search result display region R1 of the search image P1 includes a GUI for receiving the operation.

### THE CONTENTS DESCRIBED ABOVE MAY BE COMBINED IN ANY MANNER.

### APPENDIX 1

1

A molding management system that manages production of a product in a production process including an injection molding process of the product performed by an injection molding apparatus, the molding management system including: an information processing device communicably connected to a terminal device, in which the information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and in response to a received operation, displays, on a display unit, a combination of first cycle data among one or more pieces of the cycle data that are acquired and first association information indicating first injection molding condition data associated with the first cycle data among one or more pieces of the injection molding condition data that are acquired, as a first combination.

2

The molding management system according to [1], in which the cycle data and the injection molding condition data each further include apparatus identification information for identifying the injection molding apparatus.

3

The molding management system according to [1] or [2], in which the first association information is information including at least a part of the one or more pieces of injection molding condition information contained in the first injection molding condition data.

4

The molding management system according to any one of [1] to [3], in which the first association information is information including an image for receiving an operation of outputting the first injection molding condition data to another device.

5

The molding management system according to any one of [1] to [4], in which the first injection molding condition data is the injection molding condition data acquired at a past date and time closest to a date and time when the first cycle data is acquired among the one or more pieces of injection molding condition data.

6

The molding management system according to [5], in which a difference between the one or more pieces of injection molding condition data is represented by the one or more pieces of cycle-related information contained in each piece of the injection molding condition data, and the information processing device displays, on the display unit, a list of the first combination and a second combination of second cycle data acquired next to the first cycle data among the one or more pieces of cycle data and second association information indicating second injection molding condition data acquired at a past date and time closest to a date and time when the second cycle data is acquired among the one or more pieces of injection molding condition data, and when a list of the first combination and the second combination is displayed on the display unit, and when the first injection molding condition data and the second injection molding condition data are different from each other, displays information indicating that a first injection molding condition indicated by the first injection molding condition data and a second injection molding condition indicated by the second injection molding condition data are different from each other on the display unit in association with the second combination as injection molding condition change information indicating that the injection molding condition is changed.

7

The molding management system according to [6], in which when an operation on the injection molding condition change information is received, the information processing device displays, on the display unit, at least a part of the one or more pieces of injection molding condition information contained in the second injection molding condition data.

8

The molding management system according to [7], in which the information processing device displays a list of the first combination, the second combination, and a third combination on the display unit in order of date and time, the third combination including third cycle data acquired next to the second cycle data among the one or more pieces of cycle data, and third association information indicating third injection molding condition data acquired at a past date and time closest to a date and time when the third cycle data is acquired among the one or more pieces of injection molding condition data, when displaying a list of the first combination, the second combination, and the third combination on the display unit in order of date and time, displays information indicating the number of pieces of non-duplicated injection molding condition data among the first injection molding condition data, the second injection molding condition data, and the third injection molding condition data on the display unit as information indicating the number of times that the injection molding condition set in the injection molding apparatus is changed.

9

The molding management system according to [8], in which when displaying a list of the first combination, the second combination, and the third combination on the display unit, the information processing device does not display a combination corresponding to the received operation among the three combinations including the first combination, the second combination, and the third combination on the display unit.

The molding management system according to any one of [1] to [9], further including the terminal device.

The molding management system according to any one of [1] to [10], further including the injection molding apparatus.

A molding management system that manages production of a product in a production process including an injection molding process of the product performed by an injection molding apparatus, the molding management system including: an information processing device communicably connected to a terminal device, in which the information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and in response to a received operation, displays, on a display unit, first cycle data among one or more pieces of the cycle data that are acquired and first injection molding condition data associated with the first cycle data among one or more pieces of the injection molding condition data that are acquired.

### Appendix 2

### 1

A molding management system that manages production of a product in a production process including an injection molding process of the product performed by an injection molding apparatus, the molding management system including: an information processing device communicably connected to a terminal device, in which the information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and in response to a received operation, outputs, to another device, a combination of first cycle data among one or more pieces of the cycle data that are acquired and first injection molding condition data associated with the first cycle data among one or more pieces of the injection molding condition data that are acquired.

### 2

The molding management system according to [1], in which the cycle data and the injection molding condition data each further include apparatus identification information for identifying the injection molding apparatus.

### 3

The molding management system according to [1] or [2], in which the information processing device displays, on a display unit, an image for receiving an operation of outputting the combination to the other device, and outputs the combination to the other device in response to an operation received via the image.

### 4

The molding management system according to any one of [1] to [3], in which the information processing device displays, on a display unit, a combination of the first cycle data and first association information indicating the first injection molding condition data as a first combination, and outputs the first injection molding condition data to the other device when an operation on the first association information is received.

### 5

The molding management system according to any one of [1] to [4], in which the information processing device outputs the first cycle data to the other device in response to the received operation.

### 6

The molding management system according to any one of [1] to [5], in which the information processing device outputs the combination as a comma separated values (CSV) file to the other device.

### 7

The molding management system according to [6], in which in the combination to be output to the other device as the CSV file, the first cycle data and the first injection molding condition data are arranged in order of a part of the first cycle data, the first injection molding condition data, and the other part of the first cycle data.

### 8

The molding management system according to any one of [1] to [7], in which in response to the received operation, the information processing device selects one or more pieces of the injection molding condition data to be output to the other device and outputs the selected one or more pieces of injection molding condition data to the other device.

### 9

The molding management system according to [8], in which the information processing device receives an operation of selecting whether to include, in each of the selected one or more pieces of injection molding condition data, change presence-absence information indicating presence or absence of a change in the corresponding injection molding condition.

### 10

The molding management system according to any one of [1] to [9], further including the terminal device.

### 11

The molding management system according to any one of [1] to , further including the injection molding apparatus.

### 12

A data management method for a molding management system that includes an information processing device communicably connected to a terminal device and that manages production of a product in a production process including an injection molding process of the product performed by an injection molding apparatus, the data management method including an cycle data acquisition step of acquiring, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus; an injection molding condition data acquisition step of acquiring injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus; and an output step of outputting, to another device, a combination of first cycle data among one or more pieces of the cycle data acquired by the cycle data acquisition step and first injection molding condition data associated with the first cycle data among one or more pieces of the injection molding condition data acquired by the injection molding condition data acquisition step.

While the embodiment of the present disclosure has been described in detail with reference to the drawings, the specific configuration thereof is not limited to the embodiment and may be changed, replaced, deleted, or the like without departing from the spirit and scope of the present disclosure.

Further, a program for implementing a function of any component in the device described above may be recorded in a computer-readable recording medium, and the program may be read and executed by a computer system. Here, the device is, for example, the injection molding apparatus 11, the information processing device 20, the server 30, or the terminal device 40. Here, the "computer system" referred to here includes an operating system (OS) and hardware such as peripheral devices. The "computer-readable recording medium" refers to a portable medium such as a flexible disc, a magneto-optical disc, a ROM, or a compact disk (CD) ROM or a storage device such as a hard disk built in the computer system. Further, the "computer-readable recording medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the "transmission medium" for transmitting the program refers to a medium having a function of transmitting information like a network such as the Internet or a communication line such as a telephone line.

The program may be a program for implementing a part of the functions described above. Further, the program may be a so-called differential file or differential program that can implement the functions described above in combination with a program already recorded in the computer system.

What is claimed is:

1. A molding management system that manages production of a product in a production process including an injection molding process of the product performed by an injection molding apparatus, the molding management system comprising:
an information processing device communicably connected to a terminal device, wherein
the information processing device
acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus,
acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and
in response to a received operation, displays, on a display unit, a combination of first cycle data among one or more pieces of the cycle data that are acquired and first association information indicating first injection molding condition data associated with the first cycle data among one or more pieces of the injection molding condition data that are acquired, as a first combination.

2. The molding management system according to claim 1, wherein
the cycle data and the injection molding condition data each further include apparatus identification information for identifying the injection molding apparatus.

3. The molding management system according to claim 1, wherein
the first association information is information including at least a part of the one or more pieces of injection molding condition information contained in the first injection molding condition data.

4. The molding management system according to claim 1, wherein
the first association information is information including an image for receiving an operation of outputting the first injection molding condition data to another device.

5. The molding management system according to claim 1, wherein
the first injection molding condition data is the injection molding condition data acquired at a past date and time closest to a date and time when the first cycle data is acquired among the one or more pieces of injection molding condition data.

6. The molding management system according to claim 5, wherein
a difference between the one or more pieces of injection molding condition data is represented by the one or more pieces of cycle-related information contained in each piece of the injection molding condition data, and
the information processing device
displays, on the display unit, a list of the first combination and a second combination of second cycle data acquired next to the first cycle data among the one or more pieces of cycle data and second association information indicating second injection molding condition data acquired at a past date and time closest to a date and time when the second cycle data is acquired among the one or more pieces of injection molding condition data, and
when a list of the first combination and the second combination is displayed on the display unit, and when the first injection molding condition data and the second injection molding condition data are different from each other, displays information indicating that a first injection molding condition indicated by the first injection molding condition data and a second injection molding condition indicated by the second injection molding condition data are different from each other on the display unit in association with the second combination as injection molding condition change information indicating that the injection molding condition is changed.

7. The molding management system according to claim 6, wherein
when an operation on the injection molding condition change information is received, the information processing device displays, on the display unit, at least a part of the one or more pieces of injection molding condition information contained in the second injection molding condition data.

8. The molding management system according to claim 7, wherein
the information processing device
displays a list of the first combination, the second combination, and a third combination on the display unit in order of date and time, the third combination including third cycle data acquired next to the second cycle data among the one or more pieces of cycle data, and third association information indicating third injection molding condition data acquired at a past date and time closest to a date and time when the third cycle data is acquired among the one or more pieces of injection molding condition data, and
when displaying a list of the first combination, the second combination, and the third combination on the display unit in order of date and time, displays information indicating the number of pieces of non-duplicated injection molding condition data among the first injection molding condition data, the second injection molding condition data, and the third injection molding condition data on the display unit as information indicating the number of times that the injection molding condition set in the injection molding apparatus is changed.

9. The molding management system according to claim 8, wherein
when displaying a list of the first combination, the second combination, and the third combination on the display unit, the information processing device does not display a combination corresponding to the received operation among the three combinations including the first combination, the second combination, and the third combination on the display unit.

10. The molding management system according to claim 1, further comprising:
the terminal device.

11. The molding management system according to claim 1, further comprising:
the injection molding apparatus.

12. A molding management system that manages production of a product in a production process including an injection molding process of the product performed by an injection molding apparatus, the molding management system comprising:
an information processing device communicably connected to a terminal device, wherein
the information processing device
acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus,
acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and
in response to a received operation, displays, on a display unit, first cycle data among one or more pieces of the cycle data that are acquired and first injection molding condition data associated with the first cycle data among one or more pieces of the injection molding condition data that are acquired.
